(19) United States
(12) Patent Application Publication
(10) Pub. No.: US 2008/0182660 A1
(43) Pub. Date: Jul. 31, 2008

(54) Decreasing Bad Behavior With Player-Managed Online Gaming

(75) Inventors: William B. Fulton, Seattle, WA (US); Sage Merrill, Seattle, WA (US); Barton House, Woodinville, WA (US); Gerald Edsall, Sammamish, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/669,115

(22) Filed: Jan. 30, 2007

(51) Int. Cl. G06F 21/00

(52) U.S. Cl. 463/29

(57) ABSTRACT

A club may be established in an online gaming space independent of the game title. The online gaming club may include a playlist of game titles and a rule set. A user may join an online gaming session, associated with the online gaming club, of one of the game titles in the playlist. Further, the online gaming club may be updated to exclude a user whose behavior within the online gaming session is inconsistent with the rule set.

### BACKGROUND

Bad behavior by players may be a major detractor for playing video and computer games online. Bad behavior may include cheating, exploiting programming flaws present in the video game, questionable game play, and other offensive conduct. For example, packet bombing is a hardware cheat that floods an opponent's gaming device with packets rendering the online player helpless. Less sophisticated bad behavior may include harassing or harming one's teammates, known as griefing, or using foul language, for example. Bad behavior may result from the relative anonymity of the online gaming space coupled with the high levels of competition that the players experience.

Because bad behavior includes any behavior which is offensive to the other players in the online game, the standard for bad behavior may be relative to that group of players. What may be an unfair gaming practice to some players may be fair to others. Thus, bad behavior may be limited in online gaming sessions where the participants share a common standard for behavior. Generally, this may occur when the participants already know one another or have played together in the past. Organizing such games may be cumbersome and difficult. In addition, where the games are limited only to existing participants, the benefits of an open forum, such as variety of players and experiences, are lost.

Thus, there is a need to enable players of online video and computer games to establish virtual communities in the online gaming space with shared preferences and standards of behavior. Such semi-permeable online spaces may attract like-minded strangers, provide them the ability to openly and freely participate, yet provide the existing players the ability to police the developed shared preferences and standards of behavior.

### SUMMARY

A club may be established in an online gaming space independent of the game title. A request may be received to create an online gaming club. The online gaming club may include a playlist of game titles and a rule set. A user may join an online gaming session, associated with the online gaming club, of one of the game titles in the playlist. Further, the online gaming club may be updated to exclude a user whose behavior within the online gaming session is inconsistent with the rule set. For example, the offending user may be blocked from the online gaming club including online club gaming sessions across all of the game titles in the playlist. For example, the offending user may be demoted in a club membership hierarchy. For example, the rule set may define the online gaming club as private.

User preferences and club metrics may be collected. For example, user preferences and club metrics may be the result of user entered data or may be based on historic user and club game play. A user may be matched with an online gaming club based on the compatibility of the user preferences and the club metrics. The matched club may be presented to the user for initiating an online gaming session of any game title listed in the playlist.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 depicts an exemplary operating environment.

FIG. 2 depicts a online gaming system architecture.

FIGS. 3A-C depict exemplary club records and user records.

FIG. 4 illustrates an exemplary process flow for establishing a club in an online gaming space.

FIG. 5 illustrates another exemplary process flow for establishing a club in an online gaming space.

### DETAILED DESCRIPTION

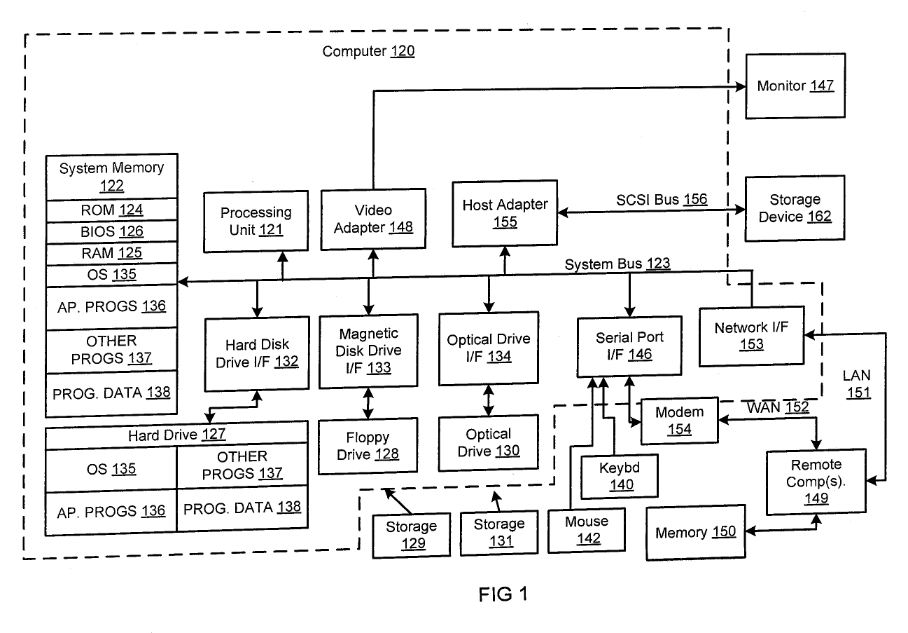

FIG. 1 and the following discussion are intended to provide a brief general description of a suitable computing environment in which the present invention and/or portions thereof may be implemented. Although not required, the invention is described in the general context of computer-executable instructions, such as program modules, being executed by a computer, such as a client workstation or a server. Generally, program modules include routines, programs, objects, components, data structures and the like that perform particular tasks or implement particular abstract data types. Moreover, it should be appreciated that the invention and/or portions thereof may be practiced with other computer system configurations, including hand-held devices, multi-processor systems, microprocessor-based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

As shown in FIG. 1, an exemplary general purpose computing system includes a conventional personal computer 120 or the like, including a processing unit 121, a system memory 122, and a system bus 123 that couples various system components including the system memory to the processing unit 121. The system bus 123 may be any of several types of bus structures including a memory bus or memory controller, a peripheral bus, and a local bus using any of a variety of bus architectures. The system memory includes read-only memory (ROM) 124 and random access memory (RAM) 125. A basic input/output system 126 (BIOS), containing the basic routines that help to transfer information between elements within the personal computer 120, such as during start-up, is stored in ROM 124.

The personal computer 120 may further include a hard disk drive 127 for reading from and writing to a hard disk (not shown), a magnetic disk drive 128 for reading from or writing to a removable magnetic disk 129, and an optical disk drive 130 for reading from or writing to a removable optical disk 131 such as a CD-ROM or other optical media. The hard disk drive 127, magnetic disk drive 128, and optical disk drive 130 are connected to the system bus 123 by a hard disk drive interface 132, a magnetic disk drive interface 133, and an optical drive interface 134, respectively. The drives and their associated computer-readable media provide non-volatile storage of computer readable instructions, data structures, program modules and other data for the personal computer 120.

Although the exemplary environment described herein employs a hard disk, a removable magnetic disk 129, and a removable optical disk 131, it should be appreciated that other types of computer readable media which can store data that is accessible by a computer may also be used in the exemplary operating environment. Such other types of media include a magnetic cassette, a flash memory card, a digital video disk, a Bernoulli cartridge, a random access memory (RAM), a read-only memory (ROM), and the like.

A number of program modules may be stored on the hard disk, magnetic disk 129, optical disk 131, ROM 124 or RAM 125, including an operating system 135, one or more application programs 136, other program modules 137 and program data 138. A user may enter commands and information into the personal computer 120 through input devices such as a keyboard 140 and pointing device 142. Other input devices (not shown) may include a microphone, joystick, game pad, satellite disk, scanner, or the like. These and other input devices are often connected to the processing unit 121 through a serial port interface 146 that is coupled to the system bus, but may be connected by other interfaces, such as a parallel port, game port, or universal serial bus (USB). A monitor 147 or other type of display device is also connected to the system bus 123 via an interface, such as a video adapter 148. In addition to the monitor 147, a personal computer typically includes other peripheral output devices (not shown), such as speakers and printers. The exemplary system of FIG. 1 also includes a host adapter 155, a Small Computer System Interface (SCSI) bus 156, and an external storage device 162 connected to the SCSI bus 156.

The personal computer 120 may operate in a networked environment using logical connections to one or more remote computers, such as a remote computer 149. The remote computer 149 may be another personal computer, a server, a router, a network PC, a peer device or other common network node, and typically includes many or all of the elements described above relative to the personal computer 120, although only a memory storage device 150 has been illustrated in FIG. 1. The logical connections depicted in FIG. 1 include a local area network (LAN) 151 and a wide area network (WAN) 152. Such networking environments are commonplace in offices, enterprise-wide computer networks, intranets, and the Internet.

When used in a LAN networking environment, the personal computer 120 is connected to the LAN 151 through a network interface or adapter 153. When used in a WAN networking environment, the personal computer 120 typically includes a modem 154 or other means for establishing communications over the wide area network 152, such as the Internet. The modem 154, which may be internal or external, is connected to the system bus 123 via the serial port interface 146. In a networked environment, program modules depicted relative to the personal computer 120, or portions thereof, may be stored in the remote memory storage device. It will be appreciated that the network connections shown are exemplary and other means of establishing a communications link between the computers may be used.

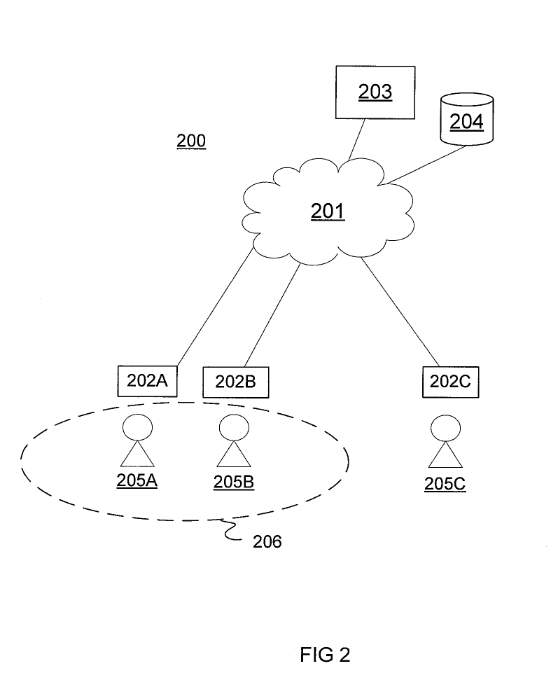

FIG. 2 depicts a online gaming system 200 architecture. The system 200 may include a data network 201, gaming devices 202A-C, a server 203, and a database 204. The data network 201 may be any system or collection of systems appropriate for the transport of data. For example, the data network 201 may be a LAN, WAN, the Internet, or the like. For example, the network 201 may support internet protocol. The network 201 may transport real-time gaming data.

Gaming devices 202A-C may connect to the network 201. The gaming device 202A-C may be any computing device adapted for online gaming. For example, the gaming device 202A-C may be a personal computer 120 loaded with one or more online game titles. For example, the gaming device 202A-C may be a console-style gaming platform, such as an Microsoft Corporation's XBOX™. The gaming device 202A-C may be a handheld device. The gaming device 202A-C may be enabled for use with one or more game titles. A game title may be a discrete application that may be loaded and run on the gaming device 202A-C. The game title may be stored on a medium readable by the gaming device 202A-C, such as a CD, DVD, game cartridge, or the like.

Typically, a user 205A-C may possess a number of game titles. The user 205A-C may load and run an individual game title onto the gaming device 202A-C to play an online game with other users that have loaded an run the same game title on their respective gaming devices 202A-C. The gaming devices 202A-C may communicate with each other across the network 201. The gaming devices 202A-C may communicate with the server 203 and the database 204.

The server 203 may be connected to the network. The server 203 may host an application that provides the management and operation of the online gaming environment. The server 203 may be implemented in a single platform or distributed across many platforms. The server 203 may authenticate the individual users 205A-C and their respective gaming devices 202A-C. The server 203 may send and receive information about the online game to and from the gaming devices 202A-C.

The server 203 may host an application with functionality to create, manage, and maintain a club 206 in the online gaming space. The server 203 may provide a management interface to create, modify, or delete a club 206. In one embodiment, the server 203 may provide the management interface to the users 205A-C via the gaming devices 202A-C. In another embodiment, the server 203 may provide management functionality and information to users via a web interface. Users 205A-C may connect to the web interface via the network 201 and a computer with browser software.

The club 206 may be defined within a online gaming space. The club 206 may be a virtual social environment for a group of users 205A-C. The club 206 may define the modes and rules within which the users 205A-C may participate in online club gaming sessions. The club 206 may be independent of the individual game titles being played. Users 205A-C may engage management user interface screens defined for the club 206. For example, a user 205A-C engage a management user interface screen via a web browser to create, join, or manage a club 206. For example, a user 205A-C may engage a management user interface screen during or in-between online gaming sessions via the gaming device 202A-C.

The server 203 may provide an interface between the gaming devices and the database 204. The database 204 may be connected to the network 201. The database 204 may contain information about users 202A-C and the club 206. The database 204 may be implemented in a single database platform or distributed across many platforms.

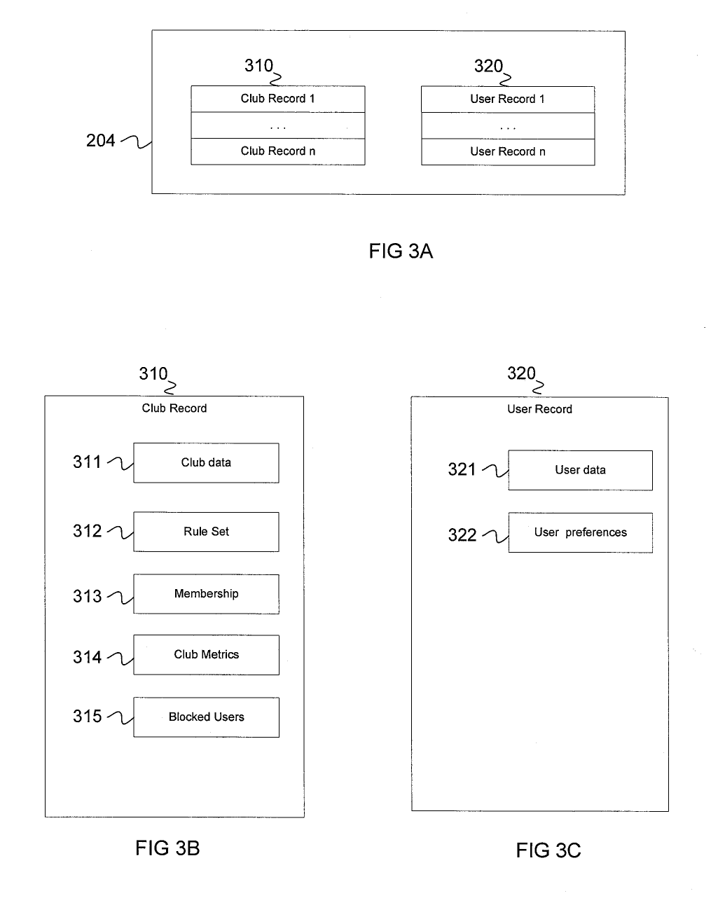

FIGS. 3A-C depict exemplary club records 310 and user records 320. While the information relating to users and clubs may be stored in any technically appropriate method and schema, in one embodiment, club records 310 and user records 320 may be stored in a database 204.

The user records 320 may include information about each user 205A-C within the online gaming system 200. Each user 205A-C may have an online gaming account. The information related to this account may be included in the user record 320. In one embodiment, each user record 320 may include user data 321 and user preferences 322.

The user data 321 may include biographical data relating to the individual user 205A-C. For example, user data 321 may include a unique username or online handle, name, address, age, sex, and the like.

The user preferences 322 may include information relating the user's online gaming preferences. The preferences 322 may list game titles and, within the game titles, the specific game maps and game modes that the user 205A-C prefers. The preferences 322 may relate to the nature of the online gaming session the user 205A-C enjoys. For example, the preferences 322 may include a desired number of players that the user 205A-C wishes to play within a given online game session. The preferences may include the time of day the user 205A-C prefers to play. The preferences 322 may include the skill level of the other user 205A-C she prefers to play.

User preferences 322 may be provided by the user 205A-C or may be determined automatically from the user's historic playing habits. For example, where user preferences 322 relate to the types of games the user enjoys, the user preferences 322 may list, automatically, the games titles the user 205A-C has historically played or the user 205A-C may indicate, by user input, specifically which game titles she most enjoys.

In one embodiment, the user preferences 322 may include information relating to the user's online gaming performance that is directly measurable. For example, it may include an assessment of the user's skill, such as average points scored per game. For example, the user preferences 322 may include an assessment of the user's sportsmanship based on feedback from other users 205A-C.

Club records 310 may include information relating to individual online gaming clubs 206. In one embodiment, the club record 310 may include club data 311, a rule set 312, a membership list 313, club metrics 314, and a blocked users list 315.

Club data 311 may include information relating to the identity of the club. For example, the club data may include a club name. The club data 311 may include an indication of the nature of the club 206 with labels such as “family,” “R&R,” “pro,” “underground,” and the like. The club data may indicate whether the club 206 is public or private. A private club may not admit visiting users who are not members. A public club may admit visiting users. In one embodiment, a public club may limit the number of visitors. Club data 311 may include information relating to the look and feel of the club 206. For example, the club data 311 may include club colors. The colors may be displayed or used when rendering management user interface screens to users 205A-C during and in-between game play. Club data 311 may include a club logo or picture. Club data 311 may include a message or statement. The message may be displayed when a user 205A-C engages a club management user interface screen.

The rule set 312 may include one or more rules that define the nature of the online gaming sessions associated with the club 206. The rule set 312 may define the nature of club member and visitor interaction. For example, the rule set 312 may include a rules that limit club membership. The rule set 312 may define the club as private and not allow access for visiting user who are not members. For example, the rule set 312 may limit the proportion of visitor-to-member ratio. To illustrate, a rule that defines the visitor-to-member ratio to 10% may allow visitor users access to club resources and online club gaming sessions so long as the number of concurrent visitors does not exceed 10% of the club population. For example, the rule set 312 may limit the ability to initiate an online club gaming session to only those users that are members of the online gaming club. In addition, the rule set 312 may require a club member be present in an online club gaming session for the duration of the online club gaming session. If no member is present during the online club gaming session, the online club gaming session may be canceled. For example, the rule set 312 may limit access to all club resources to visitors on the condition that a club member is logged-in. To illustrate, a visitor may not be presented to the online gaming club if a member is not currently accessing the management user interface or currently participating in an online club gaming session.

The rule set 312 may include rules that define the mechanics of the game play. For example, the rule set 312 may include a playlist which defines the online club gaming sessions. The playlist may include which game titles may be played and the specific game modes and maps. The rule set 312 may include a match size indicating the number of users 205A-C permitted per online club gaming session. The rule set 312 may include a match length which indicates the duration of the online club gaming session.

The rule set 312 may include rules that relate to the social aspects of game play. The rule set 312 may define acceptable social behavior within the online club gaming sessions. For example, the rule set 312 may prohibit the use of profane language. The rule set 312 may prohibit the use of hardware cheats. The rule set 312 may prohibit poor sportsmanship practices such as spawn camping, game defect exploits, and the like.

The club record 310 may define a membership 313. The membership 313 may be a listing of the individual users 205A-C that are associated with the club 206. The membership 313 may link to individual user records 320.

In one embodiment, the membership may define a hierarchy of users 205A-C within the club. The membership 313 may define club features and functions that are available to a user according to her level within the hierarchy. In one embodiment, the membership 313 may define directors, administrators, officers, and members. Users 205A-C may be excluded from club features by nature of their position in the hierarchy.

For example, directors may have all the abilities of administrators, officers, and members. In addition, directors may demote or promote users between “administrator” and “officer.” Directors may be able to access restricted portions of the club's management user interface.

For example, administrators may have all the abilities of officers and members. In addition, administrators may change club data 311 and the rule set 312. Administrators may demote or promote users between “officer” and “member.” Administrators may place users 205A-C on the blocked users list 315 permanently. Administrators may be able to access restricted portions of the club's management user interface.

For example, officers may have all the abilities of members. In addition, officers may place users 205A-C on the blocked users list 315 temporarily. Officers may promote a non-member to a “member.” Officers may be able to access restricted portions of the club's management user interface.

For example, members may enter the club and join online club gaming sessions. Members may be able to invite non-members to the club. Members may block non-members from the club. Members may access informational portions for the club's management user interface.

The club record 310 may include club metrics 314. Club metrics 314 may include measurable information about the club 206. For example, the club metrics may include open slots, current activity level, non-member return rate, officer presence, membership conversion rate, historic activity levels, the date the club 206 was established, and club milestones. Open slots may be a number representing the number of open membership positions available within the club 206. Current activity levels may indicate the number of users 205A-C in the club 206 and the number of online club gaming sessions currently in progress. Non-member return rate may represent the percentage of non-members who join a subsequent club gaming session after their initial visit. Officer presence may represent the percentage of users 205A-C in the club 206 who are officers or higher. Membership conversion rate may represent the percentage of non-members who have played in an online club gaming session and who have become members. Historic activity levels may include the number of people in the club 206 and the number of online club gaming sessions played historically. Club milestones may be a metric of how robust or stable the club 206 is. For example, the club milestones may relate to the level and consistency of club activity. Club milestones may be simplified as “gold,” “sliver,” and “bronze”, for example.

The blocked users list 315 may include a listing of users 205A-C that have been blocked from access to the club 206. Users 205A-C that have been listed as blocked users 315 may not be able to join online club gaming sessions across all game titles. Blocked users 315 may not be able to access the club management user interface. A user's status on the blocked users 315 list may be permanent or temporary. The list of blocked users 315 may include an indication of which aspects of the club from which the user 205A-C is blocked. For example, a user 205A-C may be blocked from playing a particular game mode within a title, but not blocked other game modes or from the club management interface.

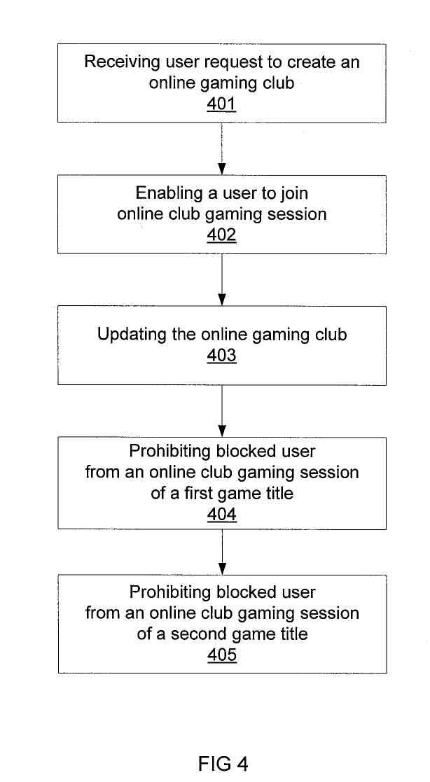

FIG. 4 illustrates an exemplary process flow for establishing a club 206 in an online gaming space. At 401, the server 203 may receive a request to create an online gaming club. The server 203 may receive the request via a web page interface or via an interface with the gaming device 205A-C. For example, the request may include a playlist, a rule set 312, and a membership 313. The server 203 may communicate with the database 204 to create a new club record 310. Once the club has been formed, users 205A-C may begin online club gaming sessions of individual game titles consistent with the rule set 312.

At 402, the server may enable a user 205A-C to join an online club gaming session. The user 205A-C may be presented with a list of club gaming sessions from which to choose. The user 205A-C may be listed in the membership 313 or may be a guest.

At 403, the online gaming club may be updated. The update may include adding, deleting, or modifying any aspect of the online gaming club records by an authorized user or system. For example, the update may include modifying the membership 313. Where the update request is from a superior user within the hierarchy, the update request may promote or demote a subordinate user. The update may include adding a specific user 205A-C to the listing of blocked users 315.

The update may include modifying club data to enforce the rule set 312. Rule enforcement may be initiated automatically by the server or by the users 205A-C. For example, the update request may be generated automatically based on gaming behavior in conflict with the rule set 312. For illustration, a rule may prohibit spawn camping, the practice of defeating an opponent immediately upon her entry into the game. For each user 205A-C, the server 203 may record the length of time each defeated opponent has been in the game. If this average time falls below a threshold, the offending user 205A-C may be warned, demoted within the membership hierarchy, or temporarily placed on the blocked users list 315, or permanently placed on the blocked users list 315.

The club members themselves may enforce the rules. For example, where a user 205A-C uses profane language in conflict with the rule set 312, the offending user 205A-C may be demoted in the membership hierarchy or may be added to the blocked users list 315.

Because the blocked users 315 data may be enforced for all club gaming session across all game titles, at 404, the blocked user is prohibited from joining an online club gaming session of a first game title, and at 405, the blocked user is prohibited from joining an online club gaming session of a second game title. The blocked user may be denied access to the club web page. Where the user 205A-C is blocked temporarily, a request to join an online club gaming session may be allowed after a designated time as expired.

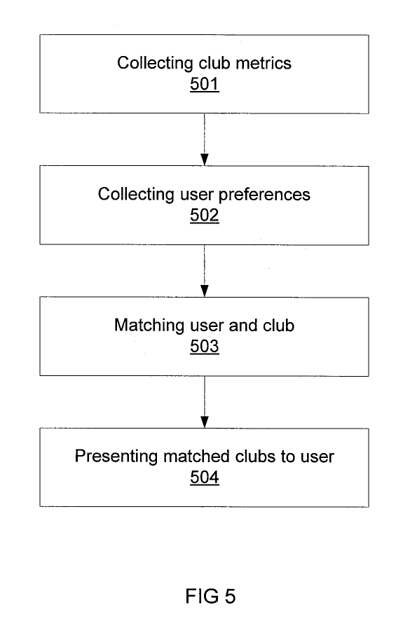

FIG. 5 illustrates an exemplary process flow for establishing a club in an online gaming space. At 501, club metrics are collected. The server 203 may monitor club activity and update the club metrics 314 of the club record 310. In one embodiment, the club metrics may be collected by user input.

At 502, user preferences 322 are collected. The server 203 may monitor user activity an update the user preferences 322 of the user record 320. In one embodiment, the user preferences 322 may be collected by user input.

At 503, a user 205A-C may be matched to a club 206. The server 203 may match a user 205A-C and a club 206 on the basis of the user metrics 323, preferences 322, club data 311, club metrics 314, and rule set 312, for example. The server 203 may compare the data associated with the user 205A-C with the data associated with the club 206 and score the compatibility. For example, if the user preferences 322 list game titles that are also listed in the playlist of the rule set 312, a high compatibility score may result. Also for example, if the club data 311 lists the club as “pro” and the user preferences 322 indicates a low skill level, a low compatibility score may result.

At 503, the matching may be responsive to some user input. In one embodiment, the matching may be incorporated into a search request. For example, the user may search for clubs 206 that play at night, and the resultant listing of clubs 206 that play at night may be sorted by compatibility and displayed to the user. In another embodiment, the matching may incorporated into a recently played list, a listing of current clubs 206, or the like. Where the user 205A-C has been blocked from a club 206, that club 206 may not appear in the listing despite its compatibility. The clubs 206 from which the user has been blocked may be concealed from the blocked user 205A-C.

At 504, clubs 206 with high compatibility scores may be presented to the user 205A-C. The user 205A-C may be able to view some club metrics 314 such as club milestones, date created, and the like. The information may be used to aid the user in deciding whether to play in an online club gaming session.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method of establishing a club in an online gaming space independent of the game title, the method comprising:
receiving from a first user a request to create an online gaming club, where the online gaming club comprises a playlist and a rule set, where the playlist comprises a plurality of game titles;
enabling a second user to join a first online gaming session of one of the game titles, where the online gaming session is associated with the online gaming club; and
updating the online gaming club to exclude the second user, where the second user's behavior within the first online gaming session is inconsistent with the rule set.

2. The method of claim 1 wherein the rule set includes rules that define acceptable social behavior within the online gaming session.

3. The method of claim 1 wherein the online gaming club further comprises a membership that identifies a hierarchy of users.

4. The method of claim 3 wherein updating the online gaming club comprises modifying the membership.

5. The method of claim 3 wherein updating the online gaming club comprises receiving an update request generated by a third user, where the third user is superior to the second user in the hierarchy.

6. The method of claim 5 wherein updating the online gaming club comprises demoting the second user within the hierarchy.

7. The method of claim 1 wherein updating the online gaming club comprises blocking the second user.

8. The method of claim 7 further comprising prohibiting the second user from joining a second online gaming session of a second game title listed in the playlist, where the second online gaming session is associated with the online gaming club.

9. The method of claim 1 wherein the rule set defines the club as private.

10. A method of establishing a club in an online gaming space independent of game title, the method comprising:
collecting a club metric indicative of an online gaming club, wherein the online gaming club comprises a playlist of a plurality of online game titles;
collecting a user preference indicative of the online gaming behavior of a first user;
matching the first user and the online gaming club based on the compatibility of the preference and the metric; and
presenting the club to the first user for initiating an online gaming session of any game title listed in the playlist.

11. The method of claim 10 where the club metric comprises user input.

12. The method of claim 10 where the club metric comprises at least one of slot availability, skill level, non-member return rate, officer presence, membership conversion rate, date established, number of players, maps, time of day, or game modes.

13. The method of claim 10 where the user preference comprises user input.

14. The method of claim 10 where the user preference comprises at least one of number of players, maps, game modes, time of day or skill level.

15. The method of claim 10 where matching is responsive to at least one of a search, a listing of recently played clubs, or a listing of current clubs.

16. The method of claim 10 where the club comprises a list of blocked users and further comprising concealing the club from a second user, where the second user is listed on the list of blocked users.

17. A method of establishing a club in an online gaming space independent of game title, the method comprising:
receiving a update request to exclude a first user from an online gaming club, wherein the online gaming club comprises a playlist of a plurality of online game titles;
denying a request from the first user to join an online gaming session of a first game title listed in the playlist; and
denying a subsequent request from the first user to join an online gaming session of a second game title listed in the playlist.

18. The method of claim 17 wherein the online gaming club comprises a rule and where the update request is generated automatically based on gaming behavior of the first user in conflict with the rule.

19. The method of claim 17 further comprising denying the first user access to a club web page.

20. The method of claim 17 further comprising allowing the first user to join an online gaming session after a designated period of time has expired since receiving the update request.
